(19) United States
(12) Patent Application Publication
(10) Pub. No.: US 2017/0316500 A1
(43) Pub. Date: Nov. 2, 2017

(54) WEB PORTAL REAL ESTATE TRADING SYSTEM

(71) Applicant: Yaser Aldineh, Dayton, OH (US)

(72) Inventor: Yaser Aldineh, Dayton, OH (US)

(21) Appl. No.: 15/142,771

(22) Filed: Apr. 29, 2016

(51) Int. Cl. G06Q 40/04; G06Q 50/16; G06Q 30/02

(52) U.S. Cl. CPC G06Q 40/04; G06Q 30/02; G06Q 50/16

(57) ABSTRACT

A web portal real-estate trading system for assisting the realtors/investors in targeting a best investment value while trading with the real-estate properties within a network. The system is configured to receive one or more attributes associated with the active list of properties and compute the investment returns of the property being traded based on the real-time market value and the market potential value associated with the selected attributes. Further, the system notifies the realtors/investors about the investment returns that can be expected for the list of properties based on which the realtors/investors can make appropriate decision while trading the active list of properties within a network.

### FIELD OF THE INVENTION

The present invention generally relates to a web portal real-estate trading system and more particularly relates to implementing a web portal real-estate trading system for assisting and guiding the realtors/investors in terms of pricing and decision making to ensure that a best investment value is determined for a plurality of active properties opted by the realtors/investors.

### BACKGROUND OF THE INVENTION

As the real estate business is gaining momentum in the industry, it becomes challenging and cumbersome for the investors/realtors to decide about the best investment value that can be expected from the active properties opted by the investors/realtors.

The existing web-based method describes an expert system that provides a logical step-by-step decision making support system that assists and guides an actual or a potential real property investor/realtor in optimizing returns from a real property investment. Further, the expert system comprises features, which automatically notify the investors when the properties that meet the investor's criteria are posted.

In addition, existing web-based method describes about a real estate investment analytics by obtaining active multiple listing service from a server database, which provides investors/realtors visual indices that allow for quick and easy apprehension of target locations that include suitable investment, and calculates a potential profit. Further, the method is about creating a heat map for locating areas where to invest based on highest sold properties and group profit range based on the geographic areas.

Another web-based method describes a website with a user/investor registration to provide an online marketplace for the investors/realtors. This website also determines return on investment of investors/realtors. Any listing as per the investor's requirement generates a notification and will send a mail to their email address. To summarize, this method is about creating market place for investors/realtors to sell and buy properties with certain type of tenants.

Further, different methods exists for creating and maintaining a database containing information relating to residential properties with automatic valuation method, which values each property received and updates the database used by the investors/realtors to analyze the property and eliminates the human analysis. The above method is about keeping a database of properties valuation to skip the requirement for investors/realtors.

As per the listed prior arts, none of the prior arts provides a quick list of best investment of active properties with a range of suggested selling price with low, high selling price, and expected return on investments. Hence, there is a need for a solution that provides various indicators for guiding and assisting investors/realtors to make best investments in terms of selling, buying, and fixing the active properties.

### SUMMARY OF THE INVENTION

The present invention relates to implementing a web portal real-estate trading system. The system assists and guides the realtors/investors in terms of pricing and decision making to ensure that the best investment value is determined for a plurality of active properties, wherein the system is configured to receive attributes associated with each of the plurality of active properties based on the interest of the realtors/investors. Further, the system is configured to determine a range of investment value for each of the plurality of active properties selected by the realtors/investors and to notify the realtors/investors with a set of messages generated based on the range of investment value determined for each of the plurality of active properties.

### BRIEF DESCRIPTION OF DRAWINGS

FIG. 1 illustrates a working overview of a web portal real-estate trading system.

FIG. 2 illustrates a flow-chart that explains the process of assisting and guiding the realtors/investors in terms of pricing and decision making to ensure that a best investment value is determined for a plurality of active properties within a network.

FIG. 3 illustrates an overview of components used to implement the web portal real-estate trading system.

FIGS. 4A and 4B illustrate a database of the active properties identified within a geographical location along with the listing of the best trading price computed for the identified active properties.

FIGS. 5A and 5B illustrate an exemplary screen shot of a graph that depicts the median price computed for a specific location based on the square feet area price of the location.

FIGS. 6A and 6B illustrate an exemplary screen shot of a graph that depicts the median price computed for the active property (ies) based on the attributes associated with the active property (ies).

FIGS. 7A and 7B illustrate an exemplary screen shot of a graph that depicts the median price of the properties sold in the nearby locations specified by the realtors/investors and based on the county assessed value for the specified property.

### FIGURE DESCRIPTION

100—A web portal real-estate trading system
101—A network within which the web portal real-estate trading system is implemented
102—An attribute input provided by the realtors/investors to the web portal real-estate trading system to select the active properties
103—A database storage with a list of active properties with computed range of values
104—A range of investment return value determined for the specified attribute input associated
with the list of active properties
105—A message notification generated based on the range of investment return value determined for the list of active properties
106—A third-party real-estate storage values integrated with the database of active property listing
200—A process that explains the method of determining a range of investment return value associated with the list of active properties
300—A system overview of components used to implement the method of determining a range of investment return value associated with the list of active properties
301—A Registration module
302—An Interface module
303—A Computation module
304—A Decision-making module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, a web portal real-estate trading system 100 is a platform that allows the realtors/investors to buy, fix, and sell the active properties by implementing a complex calculation method to determine the best investment values for the active properties selected by the realtors/investors and by considering the real-time market value and the market potential value of various factors associated with the active properties. Further, the list of active properties can be selected by the realtors/investors based on the attribute value associated with the properties. In an embodiment, the realtors/investors need to have an administrative privilege to select the list of active properties, wherein the realtors/investors who own the property can be configured to have an administrative privilege. For example: the attribute value associated with the property can be a location (street, zip code, district) of the property, the square feet area pricing of the property, the number of rooms available in the property, or the like. Further, the web portal real-estate trading system 100 is configured to display the message about the investment values computed for the active properties that in turn assists or guides the realtors/investors to take appropriate decisions for getting the best investment returns while trading the property of interest.

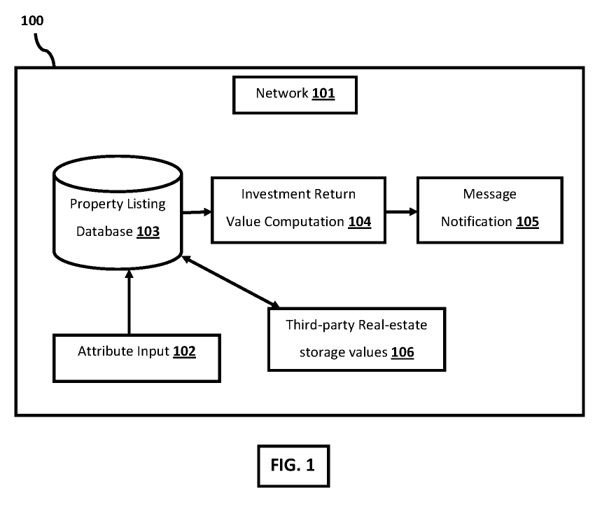

Referring to FIG. 1, illustrates a working overview of a web portal real-estate trading system 100. In an embodiment, system 100 is configured to receive one or more attributes 102 from the realtors/investors, wherein the attributes 102 are associated with the active property listing that are stored in the database storage 103.

In an embodiment, the database storage 103 is configured to store multiple trading services along with the active property listing. For example: one of the trading service can be depicting the profit range estimated for an active property through visual indices that allow for quick and easy apprehension of target locations that include suitable investment, and calculates a potential profit.

In an embodiment, the database storage 103 can be integrated with various third-party real-estate value databases 106 for determining the real-time market value and the market potential value of the active properties based on various factors or attributes associated with the active properties. In an embodiment, the third-party real-estate value databases 106 comprises of active properties, sold properties, and/or properties listed in the county records. Further, the database 106 can store the active properties extracted from external sources such as online listings such as classifieds, product web sites, blogs, articles, pin boards, news, items, and so on.

Further, the active property list is processed to determine the best investment for the property list by providing a range of investment value returns. In an embodiment, the active property list, extracted from the third-party real-estate storage database 106, is processed 104 by implementing a complex median calculation algorithm to determine the lowest, mid, and highest trading range of values for the active list of properties. Further, the system 100 notifies the realtors/investors about the range of investment values that can be expected for the list of active properties based on the current market value, the market potential value, and the attributes associated with the active properties. For example: A property ABC in a locality X with 5 bed rooms can be associated with a higher quote of $100, a mid-range of $75, and a lowest range of $65 for a realtor/investor by considering the latest market value, the market potential value, and the attributes, such as a locality, number of bed rooms associated with the property ABC.

In an embodiment, the system 100 is configured to determine the range of investment value for the active list of properties by adopting the following median computation process:
load all sold properties in the last specified number of years into a property listing database 103. In one embodiment, the properties sold within the last 3 years can be loaded in the database 103.
load all sold properties county assessed values into the property listing database 103;
calculate all sold prices to county assessed value to sold prices ratio through a computation module 104;
calculate all sold price per Square Feet (Sq. Ft) through the computation module 104;
calculate median prices per Sq. Ft. for the last specified number of days non distressed sold properties that are sold considering the attribute values such as the street, zip code and school district through the computation module 104. In one embodiment, the median price for the active property can be computed for the last 365 days.
calculate median prices per Sq. Ft. for the last specified number of days non distressed sold properties that are sold considering an individual attribute value such as the zip code, school district, an MLS defined area through the computation module 104;
calculate median county assessed value to sold prices ratio for the last specified number of days non distressed sold properties that are sold considering the attribute values such as the street, zip code, school district, and MLS defined area if available through the computation module 104;
calculate at regular intervals for the last specified number of years non distressed sold properties median price per Sq. Ft. considering each attribute value such as zip code, school district, MLS area, in the sold properties table through the computation module 104;
calculate median prices per Sq. Ft. for non-distressed active properties considering the attribute values such as the zip code, school district, MLS area through the computation module 104;
calculate median prices per Sq. Ft. for non-distressed Sold properties per active property considering the attribute values such as the street, zip code and school district, MLS area for the last year through the computation module 104;

Further, the system 100 is configured to store the calculated median prices in the property listing database 103 and the system 100 is configured to:
find the closest specified number of sales using longitude and latitude in the last specified number of years at regular intervals considering the attribute values such as the zip code, area, and school district in the property listing database 103. In one embodiment, the system 100 can be configured to find the closest specified number of sales for the last 3 years on a quarterly basis.
find the median at regular intervals based on the above calculations, median of high values, and median of low values of Price per sq. Ft considering the attribute values such as the zip code, area, and school district in the property listing database 103. In one embodiment, a median can be computed for the active properties on a quarterly basis.
find the median at regular intervals based on the above calculations, median of high values, and median of low values of Square footage considering the attribute values such as the zip code, area, and school district in the property listing database 103;
find the median at regular intervals based on the above calculations, median of high values, and median of low values of selling prices considering the attribute values such as the zip code, area, and school district in the property listing database 103;
find the median at regular intervals based on the above calculations, median of high values, and median of low values of Days on the market considering the attribute values such as the zip code, area, number of bed rooms, and school district in the property listing database 103;
find the median at regular intervals based on the above calculations, median of high values, and median of low values of County Assessed Values considering the attribute values such as the zip code, area, and school district in the property listing database 103;
find the closest specified number of sales using longitude and latitude in the last specified number of years at regular intervals considering the attribute values such as the number of bedrooms, zip code, area and school district in the property listing database 103. In one embodiment, the closest of 3 sales can be used to determine the median value at regular intervals. For example: the number of sales can be used to determine the median value on quarterly basis.
find the median at regular intervals based on the above calculations, median of high values, and median of low values of Price per sq. Ft considering the attribute values such as the number of bedrooms in the property listing database 103;
find the median at regular intervals based on the above calculations, median of high values, and median of low values of Square footage considering the attribute values such as the number of bedrooms in the property listing database 103;
find the median at regular intervals based on the above calculations, median of high values, and median of low values of selling prices considering the attribute values such as the number of bedrooms in the property listing database 103;
find the closest specified number of sales using longitude and latitude in the last specified number of years at regular intervals considering the attribute values such as the street, zip code, area, number of bed rooms, and school district in the property listing database 103;
find the median at regular intervals based on the above calculations, median of high values, and median of low values of Price per sq. Ft considering an individual attribute value such as the street in the property listing database 103;
find the median at regular intervals based on the above calculations, median of high values, and median of low values of Square footage considering an individual attribute value such as the street in the property listing database 103;
find the median at regular intervals based on the above calculations, median of high values, and median of low values of selling prices considering an individual attribute value such as the street in the property listing database 103;
find the median at regular intervals based on the above calculations, median of high values, and median of low values of Days on the market considering an individual attribute value such as the street in the property listing database 103; and
find the median at regular intervals based on the above calculations, median of high values, and median of low values of County Assessed Values considering an individual attribute value such as the street in the property listing database 103.

In an embodiment, the system 100 notifies the realtor/investor about the ranges of values through a message notification 105, which assists or guides the realtor/investor to choose the best option to be considered while trading the property.

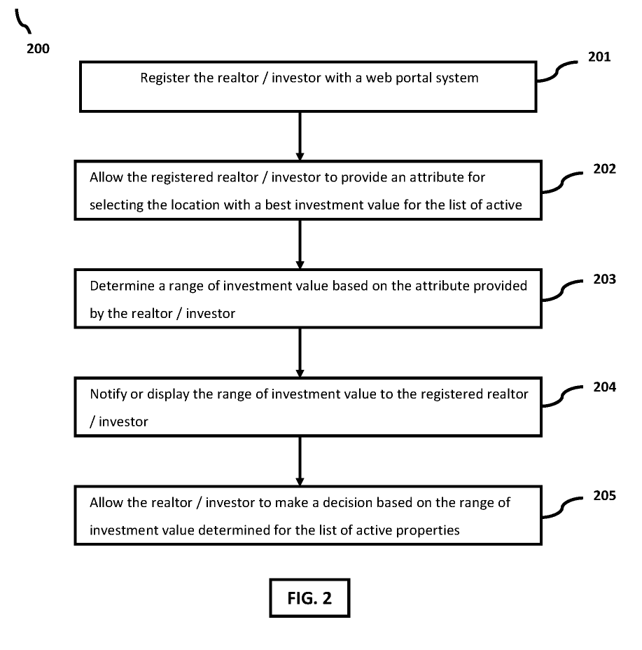

FIG. 2 illustrates a flow-chart that explains the process of assisting and guiding the realtors/investors in terms of pricing and decision making to ensure that a best investment value is determined for a plurality of active properties within a network 101. In an embodiment, at step 201, the realtor/investor is allowed to register with the system 100. As the realtor/investor is successfully registered with the system 100, at step 202, the system 100 allows the realtor/investor to provide one or more attributes associated with the active list of properties, through a web interface, to determine the best investment value. For example, the attributes associated with the properties listed in a hometown of the realtor/investor include but not limited to, the square feet area of the living room, number of balconies available, the kind of flooring used in the property list, number of public gardens seen around the property. Further, at step 203, the system 100 is configured to compute the range of investment values for the property based on the attributes selected by the realtor/investor and based on the real-time market value of the selected property and the market potential value of the property. Further, at step 204, the system 100 notifies/displays the range of investment values associated with the property that is computed, in the form of message notification, based on the selected attributes and the real-time market value of the selected attributes. Further, at step 205, the system 100 allows the realtors/investors to make a decision about the property trading based on the message notification shared with the realtor/investor through the system 100.

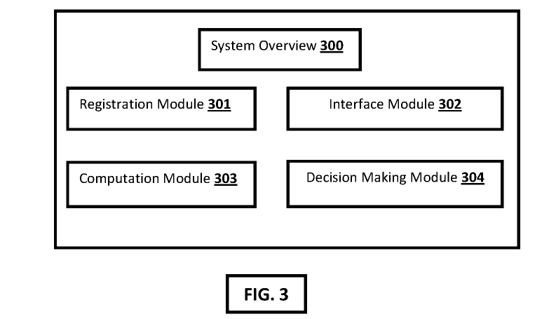

FIG. 3 illustrates an overview of components used to implement the web portal real-estate trading system 100. In an embodiment, the overview of components used to implement the system 100 comprises of: a Registration module 301, an Interface module 302, a Computation module 303, and a Decision making module 304. The Registration module 301 is configured to register the realtors with the system 100. Upon successfully registering the realtors/investors with the system 100, the system 100 allows the realtors/investors to specify the attributes associated with the list of active properties within a network 101 through an Interface module 302. Further, as the realtors/investors specify the attributes associated with the list of active properties, the Computation module 303 is configured to compute the range of investment value for the active list of properties by implementing a complex algorithm. The algorithm computes the range of investment value based on the real-time market value of the attributes associated with the property list and the market potential value of the attributes associated with the property list. Further, the Decision making module 304 is configured to notify the realtors/investors about the range of investment value for the active list of properties identified within a network 101 and assist/guides the realtors/investors to take appropriate decision regarding the real-estate trading based on these computed values.

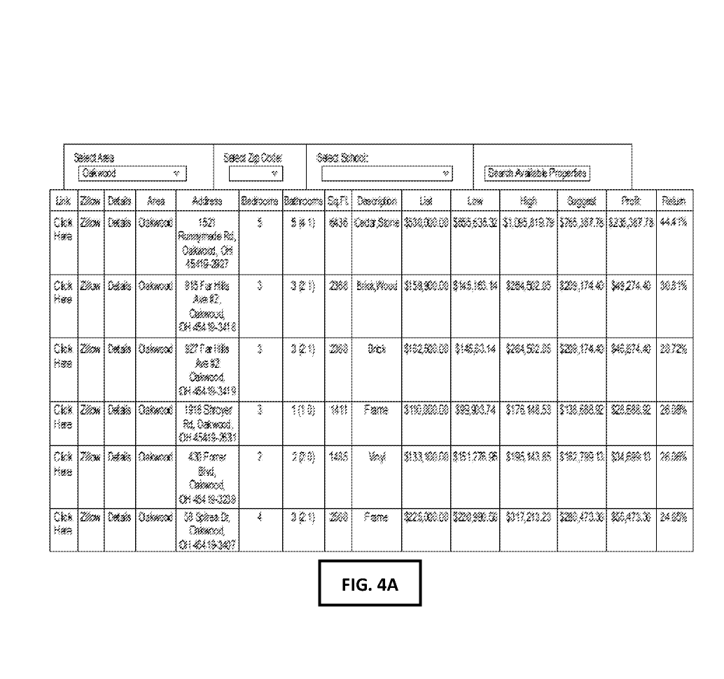

FIGS. 4A and 4B illustrate a database of the active properties identified within a geographical location along with the listing of the best trading price computed for the identified active properties. As depicted in the screen-shot, the realtors/investors are allowed to enter the attributes associated with the active list of properties through a web interface (fields shown in the top portion of the screen). Further, based on the attributes selected by the realtors/investors, the web interface tabulates the active list of properties associated with the attributes. Further, the tabulated screen-shot displays the best selling price for the list of active properties by computing the values based on the selected attributes and the real-time current value of the selected attributes. Further, the web interface displays the selling price values of the active properties in a specific order.

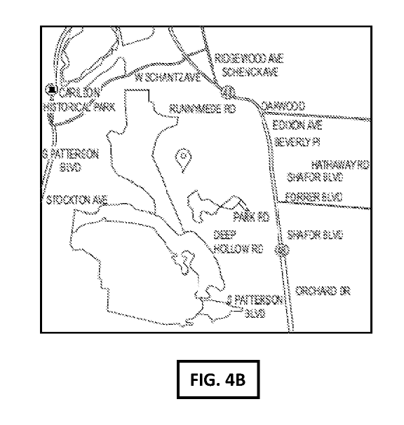

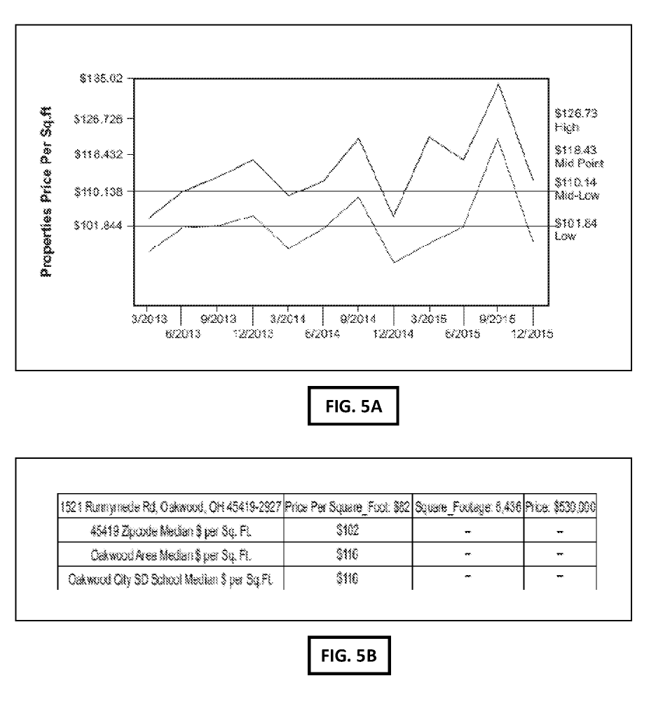

FIGS. 5A and 5B illustrate an exemplary screen shot of a graph that depicts the median price computed for a specific location based on the square feet area price of the location. FIG. 5A, depicts the median price computed for various properties identified within a specific location. The range of values computed is represented as high, low, and mid-range values. For example, the location can be represented by zip code, area, school district, or the like. FIG. 5B, depicts the average pricing of the properties located within a specific boundary, which is tabulated in square foot.

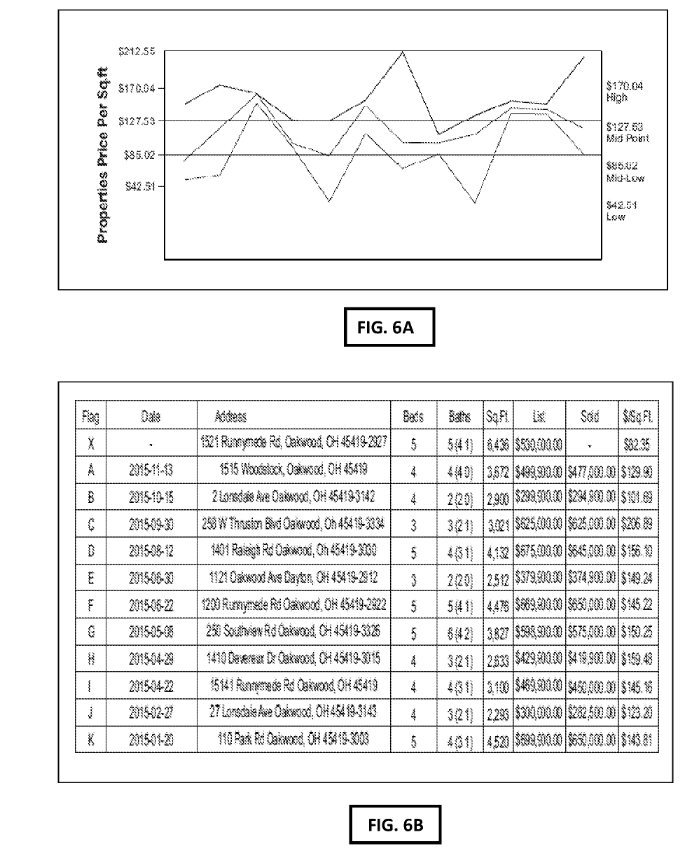

FIGS. 6A and 6B illustrate an exemplary screen shot of a graph that depicts the median price computed for the active property (ies) based on the attributes associated with the active property (ies). FIG. 6A, depicts a graph computed with median values for the property (ies) based on the attributes associated with the active property (ies). The median values are computed at regular interval of time to determine the average median range of values for the interested properties. FIG. 6B, depicts the trading values computed for the property (ies) based on the attributes associated with the active property (ies). For example, the active property (ies) can include the attributes associated with the property (ies) such as the number of bed rooms, the pricing of the rooms sold last year, the pricing of the rooms per square feet.

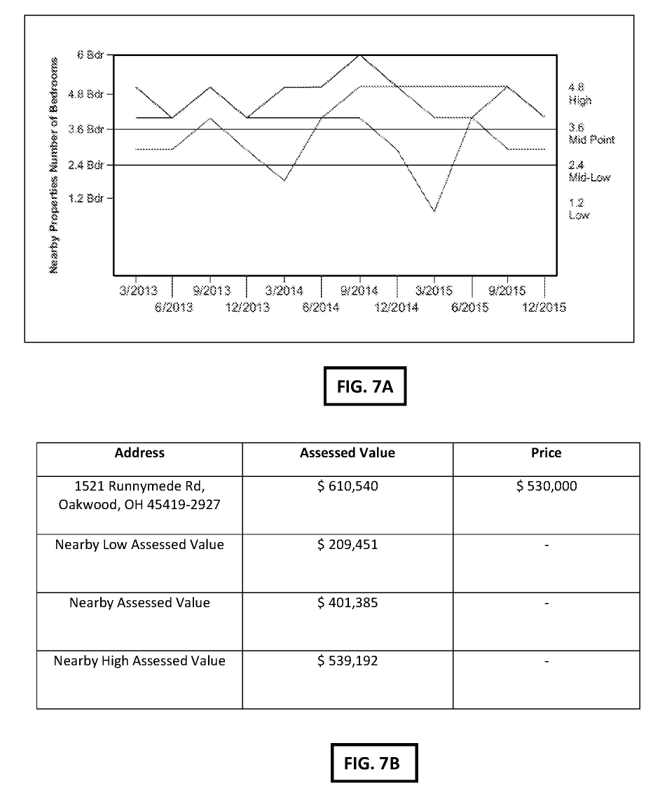

FIGS. 7A and 7B illustrate an exemplary screen shot of a graph that depicts the median price of the properties sold in the nearby locations specified by the realtors/investors and based on the county assessed value associated with the specified property. FIG. 7A, depicts the range of values of the properties that are sold within the specified location along with the attributes associated with the identified properties. FIG. 7B, depicts the county assessed values for the active properties that are sold within the vicinity of the specified location.

1. A web portal real-estate trading system that assists and guides at least one realtor/investor in terms of pricing and decision making to ensure best investment value determined for a plurality of active properties within a network, wherein said system comprises of a property listing database and a computation module configured to:
receive at least one attribute associated with each of said plurality of active properties based on the interest of said at least one realtor/investor;
determine a range of investment value for each of said plurality of active properties selected by said at least one realtor/investor by adopting a median computation process; and
notify said at least one realtor/investor with a set of messages generated based on the range of investment value determined for each of said plurality of active properties.

2. The system as claimed in claim 1, wherein said system is configured to determine the range of investment value for purchasing, fixing, and selling each of said plurality of active properties identified based on the interest of said at least one realtor/investor.

3. The system as claimed in claim 2, wherein said system is configured to determine the range of investment value by adopting the following median computation process:
load all sold properties in the last specified number of years into the property listing database;
load all sold properties county assessed values into the property listing database;
calculate all sold prices to county assessed value to sold prices ratio through the computation module, which is further stored in the property listing database;
calculate all sold price per Sq. Ft through the computation module, which is further stored in the property listing database;
calculate median prices per Sq. Ft. for the last specified number of days non distressed sold properties that are sold considering the attribute values such as street, zip code, MLS defined area, and school district through the computation module, which is further stored in the property listing database;
calculate median county assessed value to sold prices ratio for the last specified number of days non distressed sold properties that are sold considering the attribute values such as street, zip code, school district and MLS defined Area if available through the computation module, which is further stored in the property listing database;
calculate at regular intervals for the last specified number of years non distressed sold properties median price per Sq. Ft. for each attribute value such as zip code, school district, MLS area, in the sold properties table through the computation module, which is further stored in the property listing database;
calculate median prices per Sq. Ft. for non-distressed active properties considering the attribute values such as the zip code, school district, MLS area through the computation module, which is further stored in the property listing database;
calculate median prices per Sq. Ft. for non-distressed Sold properties per active property considering the attribute values such as the street, zip code, MLS area, and school district for the last year through the computation module, which is further stored in the property listing database;
find the closest specified number of sales using longitude and latitude in the last specified number of years at regular intervals considering the attribute values such as the zip code, area, and school district in the property listing database;
find the median at regular intervals based on the above calculations, median of high values, and median of low values of Price per sq. Ft considering the attribute values such as the zip code, area and school district in the property listing database;
find the median at regular intervals based on the above calculations, median of high values, and median of low values of Square footage considering the attribute values such as the zip code, area, and school district in the property listing database;
find the median at regular intervals based on the above calculations, median of high values, and median of low values of selling prices considering the attribute values such as the zip code, area, and school district in the property listing database;
find the median at regular intervals based on the above calculations, median of high values, and median of low values of Days on the market considering the attribute values such as the zip code, area, and school district in the property listing database;
find the median at regular intervals based on the above calculations, median of high values, and median of low values of County Assessed Values considering the attribute values such as the zip code, area, and school district in the property listing database;
find the closest specified number of sales using longitude and latitude in the last specified number of years at regular intervals considering the attribute values such as the number of bedrooms, zip code, area and school district in the property listing database;
find the median at regular intervals based on the above calculations, median of high values, and median of low values of Price per sq. Ft considering the attribute values such as the number of bedrooms in the property listing database;
find the median at regular intervals based on the above calculations, median of high values, and median of low values of Square footage considering the attribute values such as the number of bedrooms in the property listing database;
find the median at regular intervals based on the above calculations, median of high values, and median of low values of selling prices considering the attribute values such as the number of bedrooms in the property listing database;
find the median at regular intervals based on the above calculations, median of high values, and median of low values of Days on the market considering the attribute values such as the number of bedrooms in the property listing database;
find the median at regular intervals based on the above calculations, median of high values, and median of low values of County Assessed Values considering the attribute values such as the number of bedrooms in the property listing database;
find the closest specified number of sales using longitude and latitude in the last specified number of years at regular intervals considering the attribute values such as the street, zip code, area, number of bedrooms, and school district in the property listing database;
find the median at regular intervals based on the above calculations, median of high values, and median of low values of Price per sq. Ft considering an individual attribute value such as the street in the property listing database;
find the median at regular intervals based on the above calculations, median of high values, and median of low values of Square footage considering an individual attribute value such as the street in the property listing database;
find the median at regular intervals based on the above calculations, median of high values, and median of low values of selling prices considering an individual attribute value such as the street in the property listing database;
find the median at regular intervals based on the above calculations, median of high values, and median of low values of Days on the market considering an individual attribute value such as the street in the property listing database; and
find the median at regular intervals based on the above calculations, median of high values, and median of low values of County Assessed Values considering an individual attribute value such as the street in the property listing database.

4. The system as claimed in claim 2, wherein said system is configured to support the realtors/investors with an administrative privilege (who own the list of active properties) to select the list of active properties and the realtors/investors.

5. A method implemented in a web portal real-estate trading system that assists and guides at least one realtor/investor in terms of pricing and decision making to ensure best investment value determined for a plurality of active properties within a network, wherein said method comprises of:
receiving at least one attribute associated with each of said plurality of active properties based on the interest of said at least one realtor/investor;
determining a range of investment value for each of said plurality of active properties that is selected by said at least one realtor/investor by adopting a median computation process; and
notifying said at least one realtor/investor with a set of messages generated based on the range of investment value determined for each of said plurality of active properties.

6. The method as claimed in claim 5, wherein said method determines the range of investment value for purchasing, fixing, and selling each of said plurality of active properties that are identified based on the interest of said at least one realtor/investor.

7. The method as claimed in claim 6, wherein said method determines the range of investment value by adopting the following median computation process:
loading all sold properties in the last specified number of years into a property listing database;
loading all sold properties county assessed values into a property listing database;
calculating all sold prices to county assessed value to sold prices ratio through a computation module, which is stored in the property listing database;
calculating all sold price per Sq. Ft through the computation module, which is stored in the property listing database;
calculating median prices per Sq. Ft. for the last specified number of days non distressed sold properties that are sold considering the attribute values such as street, zip code, school district, and MLS defined area if available through the computation module, which is stored in the property listing database;
calculating median county assessed value to sold prices ratio for the last specified number of days non distressed sold properties that are sold considering the attribute values such as the street, zip code, school district, and MLS defined area if available through the computation module, which is stored in the property listing database;
calculating at regular intervals for the last specified number of years non distressed sold properties median price per Sq. Ft. considering individual attribute values such as zip code, school district, MLS area, street, in the sold properties table through the computation module, which is stored in the property listing database;
calculating median prices per Sq. Ft. for non-distressed active properties considering the attribute values such as street, zip code, MLS area, and school district through the computation module, which is stored in the property listing database;
calculating median prices per Sq. Ft. for non-distressed Sold properties per active property considering the attributes such as street, zip code, MLS area, and school district for the last year through the computation module, which is stored in the property listing database;
finding the closest specified number of sales using longitude and latitude in the last specified number of years at regular intervals considering the attribute values such as zip code, area and school district in the property listing database;
finding the median at regular intervals based on the above calculations, median of high values, and median of low values of Price per sq. Ft within the same zip code, area and school district in the property listing database;
finding the median at regular intervals based on the above calculations, median of high values, and median of low values of Square footage considering the attribute values such as zip code, area, and school district in the property listing database;
finding the median at regular intervals based on the above calculations, median of high values, and median of low values of selling prices considering the attribute values such as zip code, area and school district in the property listing database;
finding the median at regular intervals based on the above calculations, median of high values, and median of low values of Days on the market considering the attribute values such as zip code, area and school district in the property listing database;
finding the median at regular intervals based on the above calculations, median of high values, and median of low values of County Assessed Values within the same zip code, area and school district in the property listing database;
finding the closest specified number of sales using longitude and latitude in the last specified number of years at regular intervals considering the attribute values such as the number of bedrooms, zip code, area and school district in the property listing database;
finding the median at regular intervals based on the above calculations, median of high values, and median of low values of Price per sq. Ft considering individual attribute values such as number of bedrooms in the property listing database;
finding the median at regular intervals based on the above calculations, median of high values, and median of low values of Square footage considering the individual attribute values such as the number of bedrooms in the property listing database;
finding the median at regular intervals based on the above calculations, median of high values, and median of low values of selling prices considering the individual attribute values such as the number of bedrooms in the property listing database;
finding the median at regular intervals based on the above calculations, median of high values, and median of low values of Days on the market considering the individual attribute values such as the number of bedrooms in the property listing database;
finding the median at regular intervals based on the above calculations, median of high values, and median of low values of County Assessed Values considering the attribute values such as the number of bedrooms in the property listing database;
finding the closest specified number of sales using longitude and latitude in the last specified number of years at regular intervals considering the attribute values such as street, zip code, area, school district, number of bedrooms in the property listing database;
finding the median at regular intervals based on the above calculations, median of high values, and median of low values of Price per sq. Ft considering the individual attribute value such as street in the property listing database;
finding the median at regular intervals based on the above calculations, median of high values, and median of low values of Square footage considering the individual attribute value such as street in the property listing database;
finding the median at regular intervals based on the above calculations, median of high values, and median of low values of selling prices considering the individual attribute value such as street in the property listing database;
finding the median at regular intervals based on the above calculations, median of high values, and median of low values of Days on the market considering the individual attribute value such as street in the property listing database; and
finding the median at regular intervals based on the above calculations, median of high values, and median of low values of County Assessed Values considering the individual attribute value such as street in the property listing database.

8. A computer program product comprising computer executable program code recorded on a computer readable non-transitory storage medium, said computer executable program code when executed assists and guides at least one realtor in terms of pricing and decision making to ensure best investment value determined for a plurality of active properties within a network, causing the actions including:
receiving at least one attribute associated with each of said plurality of active properties based on the interest of said at least one realtor/investor;
determining a range of investment value for each of said plurality of active properties that is selected by said at least one realtor/investor by adopting a median computation process; and
notifying said at least one realtor with a set of messages generated based on the range of investment value determined for each of said plurality of active properties.

9. The computer program product as claimed in claim 8, wherein said product is configured to determine the range of investment value for purchasing, fixing, and selling said plurality of active properties identified based on the interest of said at least one realtor/investor.

10. The computer program product as claimed in claim 9, wherein said product is configured to determine the range of investment value by adopting the following the median computation process:
loading all sold properties in the last specified number of years into a property listing database;
loading all sold properties county assessed values into a property listing database;
calculating all sold prices to county assessed value to sold prices ratio through a computation module, which is stored in the property listing database;
calculating all sold price per Sq. Ft through the computation module, which is stored in the property listing database;
calculating median prices per Sq. Ft. for the last specified number of days non distressed sold properties that are sold considering the attribute values such as street, zip code, school district, and MLS defined area if available through the computation module, which is stored in the property listing database;
calculating median county assessed value to sold prices ratio for the last specified number of days non distressed sold properties that are sold considering the attribute values such as the street, zip code, school district, and MLS defined area if available through the computation module, which is stored in the property listing database;
calculating at regular intervals for the last specified number of years non distressed sold properties median price per Sq. Ft. considering individual attribute values such as zip code, school district, MLS area, street, in the sold properties table through the computation module, which is stored in the property listing database;
calculating median prices per Sq. Ft. for non-distressed active properties considering the attribute values such as street, zip code, MLS area, and school district through the computation module, which is stored in the property listing database;
calculating median prices per Sq. Ft. for non-distressed Sold properties per active property considering the attributes such as street, zip code, MLS area, and school district for the last year through the computation module, which is stored in the property listing database;
finding the closest specified number of sales using longitude and latitude in the last specified number of years at regular intervals considering the attribute values such as zip code, area and school district in the property listing database;
finding the median at regular intervals based on the above calculations, median of high values, and median of low values of Price per sq. Ft within the same zip code, area and school district in the property listing database;
finding the median at regular intervals based on the above calculations, median of high values, and median of low values of Square footage considering the attribute values such as zip code, area, and school district in the property listing database;
finding the median at regular intervals based on the above calculations, median of high values, and median of low values of selling prices considering the attribute values such as zip code, area and school district in the property listing database;
finding the median at regular intervals based on the above calculations, median of high values, and median of low values of Days on the market considering the attribute values such as zip code, area and school district in the property listing database;
finding the median at regular intervals based on the above calculations, median of high values, and median of low values of County Assessed Values within the same zip code, area and school district in the property listing database;
finding the closest specified number of sales using longitude and latitude in the last specified number of years at regular intervals considering the attribute values such as the number of bedrooms, zip code, area and school district in the property listing database;
finding the median at regular intervals based on the above calculations, median of high values, and median of low values of Price per sq. Ft considering individual attribute values such as number of bedrooms in the property listing database;
finding the median at regular intervals based on the above calculations, median of high values, and median of low values of Square footage considering the individual attribute values such as the number of bedrooms in the property listing database;
finding the median at regular intervals based on the above calculations, median of high values, and median of low values of selling prices considering the individual attribute values such as the number of bedrooms in the property listing database;
finding the median at regular intervals based on the above calculations, median of high values, and median of low values of Days on the market considering the individual attribute values such as the number of bedrooms in the property listing database;
finding the median at regular intervals based on the above calculations, median of high values, and median of low values of County Assessed Values considering the attribute values such as the number of bedrooms in the property listing database;
finding the closest specified number of sales using longitude and latitude in the last specified number of years at regular intervals considering the attribute values such as street, zip code, area, school district, number of bedrooms in the property listing database;
finding the median at regular intervals based on the above calculations, median of high values, and median of low values of Price per sq. Ft considering the individual attribute value such as street in the property listing database;
finding the median at regular intervals based on the above calculations, median of high values, and median of low values of Square footage considering the individual attribute value such as street in the property listing database;
finding the median at regular intervals based on the above calculations, median of high values, and median of low values of selling prices considering the individual attribute value such as street in the property listing database;
finding the median at regular intervals based on the above calculations, median of high values, and median of low values of Days on the market considering the individual attribute value such as street in the property listing database; and
finding the median at regular intervals based on the above calculations, median of high values, and median of low values of County Assessed Values considering the individual attribute value such as street in the property listing database.
